(19) United States
(12) Patent Application Publication
(10) Pub. No.: US 2008/0161028 A1
(43) Pub. Date: Jul. 3, 2008

(54) Methods, systems and computer program products for a redundant, geographically diverse, and independently scalable message service (MS) content store

(75) Inventors: Virginia B. Fonde, Raleigh, NC (US); Apirux Bantukul, Cary, NC (US); Douglas Appleyard, Raleigh, NC (US); Patricia A. Baldwin, Raleigh, NC (US); Peter J. Marsico, Chapel Hill, NC (US)

Correspondence Address: JENKINS, WILSON, TAYLOR & HUNT, P. A., 3100 TOWER BLVD., Suite 1200, DURHAM, NC, 27707, US

(73) Assignee: Tekelec

(21) Appl. No.: 11/903,507

(22) Filed: Sep. 21, 2007

Related U.S. Application Data
(60) Provisional application No. 60/878,488, filed on Jan. 3, 2007.

(51) Int. Cl. H04Q 7/20

(52) U.S. Cl. 455/466

(57) ABSTRACT

The subject matter described herein includes methods, systems and computer program products for a redundant, geographically diverse, and independently scalable message service (MS) content store system. According to one aspect, the system includes a content store function (CSF) including at least one content store (CS) configured to store message service messages, initiate delivery attempts for the message service messages, and maintain a message retry attempt schedule for unsuccessful delivery attempts. The system also includes a message server function (MSF) including at least one message server (MS) configured to route and deliver the message service messages, wherein the MSF is scalable independently from the CSF.

### RELATED APPLICATIONS

This application claims the benefit of U.S. provisional patent application No. 60/878,488, filed Jan. 3, 2007, the disclosure of which is incorporated herein by reference in its entirety.

### TECHNICAL FIELD

The subject matter described herein relates to providing message service (MS) to subscribers with MS capable devices. More specifically, the subject matter relates to methods, systems and computer program products for a redundant, geographically diverse, and independently scalable MS content store.

### BACKGROUND

In telecommunications networks, subscribers can send text messages to each other using short message service (SMS). Similarly, subscribers can send multimedia messages, such as image, audio, and/or video messages to each other using multimedia message service (MMS). The term “message service,” as used herein is intended to refer to SMS, MMS, or any other service by which telecommunications service subscribers can send messages to each other separate from voice calls. The term “message service message,” as used herein is intended to refer to SMS, MMS, or any other type of message that may be sent between telecommunications service subscribers separately from voice calls.

Message service message delivery can be broadly divided into two categories, deliver-on-first-attempt message delivery and store-and-forward message delivery. MS messages, such as instant messages (IM), that are processed by message service network elements configured for deliver-on-first-attempt message delivery are attempted to be delivered once. If the destination is unavailable, the messages are discarded. Examples of MS messages that may be processed deliver-on-first-attempt include contest-related voting messages as well as ads.

MS messages processed deliver-on-first-attempt can produce potentially unwanted results. For example, in the event that an initial delivery attempt is unsuccessful, the message is lost. This delivery method offers no protection from network outages or other communications problems.

Messages processed in a message service for store-and-forward message delivery, on the other hand, can be cumbersome to both carriers and subscribers because such messages require large amounts of storage for storing messages until delivery, and additional processing for performing multiple delivery attempts. In communications networks with average uptime and a small volume of messages transmitted between subscribers, store-and-forward message delivery is desirable and efficient because it is capable of delivering a high percentage of messages via an unreliable network. However, as MS message volume increases, the storage and processing burdens on network nodes, such as message servers, that share the messages and re-attempt delivery becomes great.

Messages that are stored awaiting additional delivery attempts are placed in message queues. When multiple messages to a subscriber cannot be delivered, they are stored in an order based on a predetermined criteria, such as the order in which they were received. When a subscriber's MS device reconnects to the network or otherwise becomes available, a message server typically retrieves queued messages stored in the database for that subscriber and transmits the messages to the subscriber in sequence.

Current MS systems achieve store-and-forward functionality by distributing message centers throughout their network. Individual message servers combine message storage and routing functions into a single hardware platform. If additional message storage or routing capacity is desired, additional message centers are added to the network.

Current network trends are moving away from unreliable networks that process a small number of short text messages towards more reliable networks, in which subscribers are almost constantly connected to the network and transmit an increasing number of multimedia messages that include images, video, and audio. Store-and-forward message delivery in this environment requires very large amounts of storage, and places a heavy burden on subscribers to check for incoming messages. Conversely, while immediate delivery methods would eliminate the storage requirements for carriers and deliver a high percentage of messages to subscribers, the burden of tracking undelivered messages and resending them is unacceptable to many subscribers. Carriers employing store-and-forward MS systems adjust to current trends by continuously adjusting their storage and routing capacity through the addition or removal of message centers from their networks. However, typical message server designs can limit a carrier's ability to efficiently balance message storage and routing functions within their network because both functions are not separately scalable. Moreover, in the event of a hardware failure, such designs cannot robustly recover from the failure and maintain high levels of availability to subscribers. Thirdly, networks in which an asymmetry exists regarding the way in which subscribers use the messaging system are difficult for current message centers to handle efficiently.

For example, a carrier may operate a network covering two regions, also called points of presence (POP). Subscribers in the first region may be the recipients of many large messages, but connect to the network infrequently in order to retrieve their messages. Subscribers in the second region may have different messaging patterns. These subscribers may instead transmit numerous small text messages, which are not stored for long periods because these subscribers may be continuously connected to very reliable components in the network. In order to provide message service for each set of subscribers, an equal number of message centers may be deployed in each region. In this scenario, storage capacity in the first region is fully utilized, while most message routing capacity goes unused. Conversely, in the second region, routing capacity is fully utilized, while message storage capacity is underutilized. Therefore, asymmetrical network usage generates inefficiencies when used with current message service technologies.

Another drawback of current message service technologies is an inability to maintain high-availability to subscribers in the event of hardware or network failures. In the event that a message server, or a component thereof, fails, the service to subscribers homed to that message server may be restricted or suspended because message servers have no ability to redistribute messages to other message servers.

Therefore, a need exists for methods, systems and computer program products for a redundant, geographically diverse, and independently scalable message service content store.

### SUMMARY

The subject matter described herein includes methods, systems and computer program products for a redundant, geographically diverse, and independently scalable message service (MS) content store system. According to one aspect, the system includes a content store function (CSF) including at least one content store (CS) configured to store message service messages, initiate delivery attempts for the message service messages, and maintain a message retry attempt schedule for unsuccessful delivery attempts. The system also includes a message server function (MSF) including at least one message server (MS) configured to route and deliver the message service messages, wherein the MSF is scalable independently from the CSF.

According to another aspect, the system includes a CSF and an MSF located in separate geographical locations. The CSF includes a database function (DBF) that includes a content store database (CSDB) for storing subscriber information and message service messages, a store manager function (SMF) including at least one store manager (SM) for managing the message service messages, queuing the message service messages, and initiating retries for the failed deliveries, wherein the SMF is scalable independently from the DBF. The system also includes a store portal function (SPF) including at least one store portal (SP) for interfacing with MSF, SMF, and DBF, where the SPF is scalable independently from the SMF and DBF.

According to another aspect, the system may include a CSF divided into a plurality of content store sites (CSSs), wherein each CSS is connected to at least one other CSS and configured to detect the unavailability of a CSS component and perform the functions formerly performed by the unavailable component.

According to another aspect, the method includes receiving, at an MSF including at least one MS, a message service message. Using the MSF, the at least one message service message is routed to a CSF that includes at least one CS, where the at least one CS is configured to store message service messages, initiate delivery attempts for the message service messages, and maintain a message retry attempt schedule for unsuccessful delivery attempts and is independently scalable from the MSF. The message service message is processed using the CSF.

The subject matter described herein may be implemented using a computer program product comprising computer executable instructions embodied in a computer readable medium. Exemplary computer readable media suitable for implementing the subject matter described herein include chip memory devices, disc memory devices, application specific integrated circuits, programmable logic devices, and downloadable electrical signals. In addition, a computer program product that implements a subject matter described herein may reside on a single device or computing platform or maybe distributed across multiple devices or computing platforms.

### BRIEF DESCRIPTION OF THE DRAWINGS

The subject matter described herein will now be explained with reference to the accompanying drawings of which:

FIG. 1A is a block diagram of a redundant and independently scalable message service content store system according to the subject matter described herein;

FIG. 1B is a block diagram of a geographically diverse, redundant, and independently scalable message service content store system according to the subject matter described herein; and

FIG. 2 is a flow chart illustrating exemplary steps for providing messaging services in a geographically diverse, redundant, and independently scalable message service content store system according to the subject matter described herein.

### DETAILED DESCRIPTION

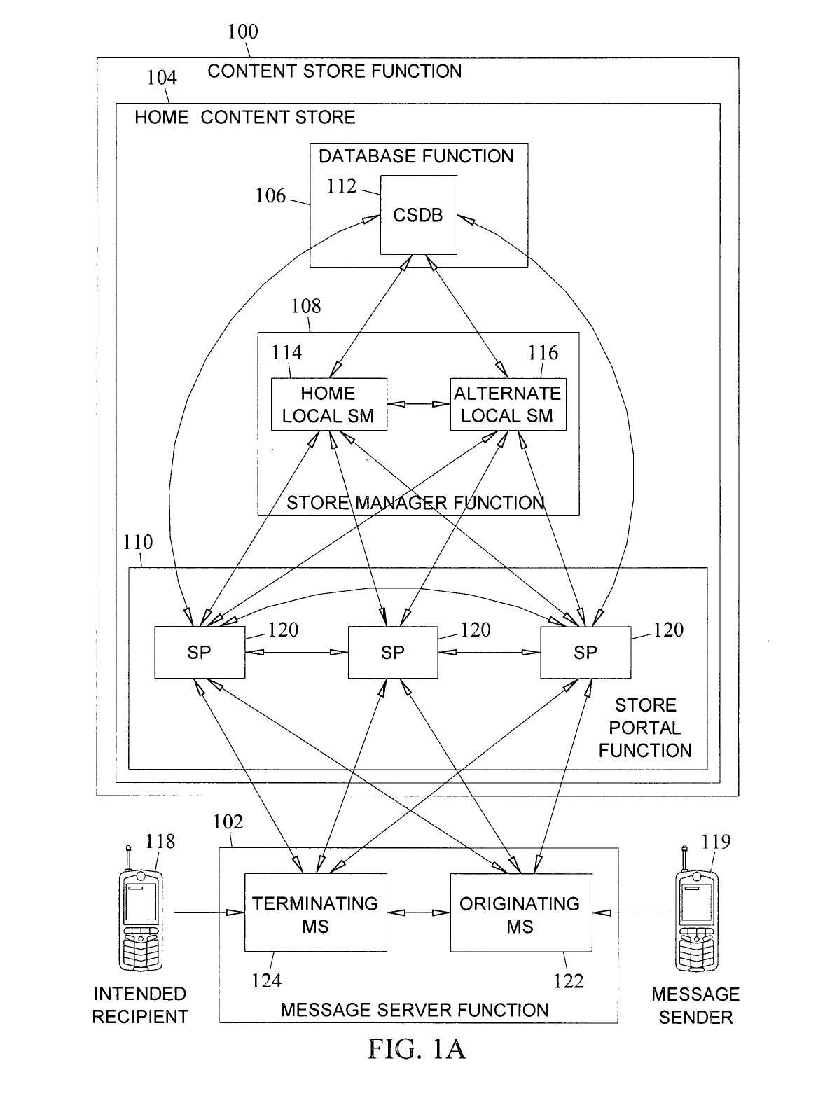

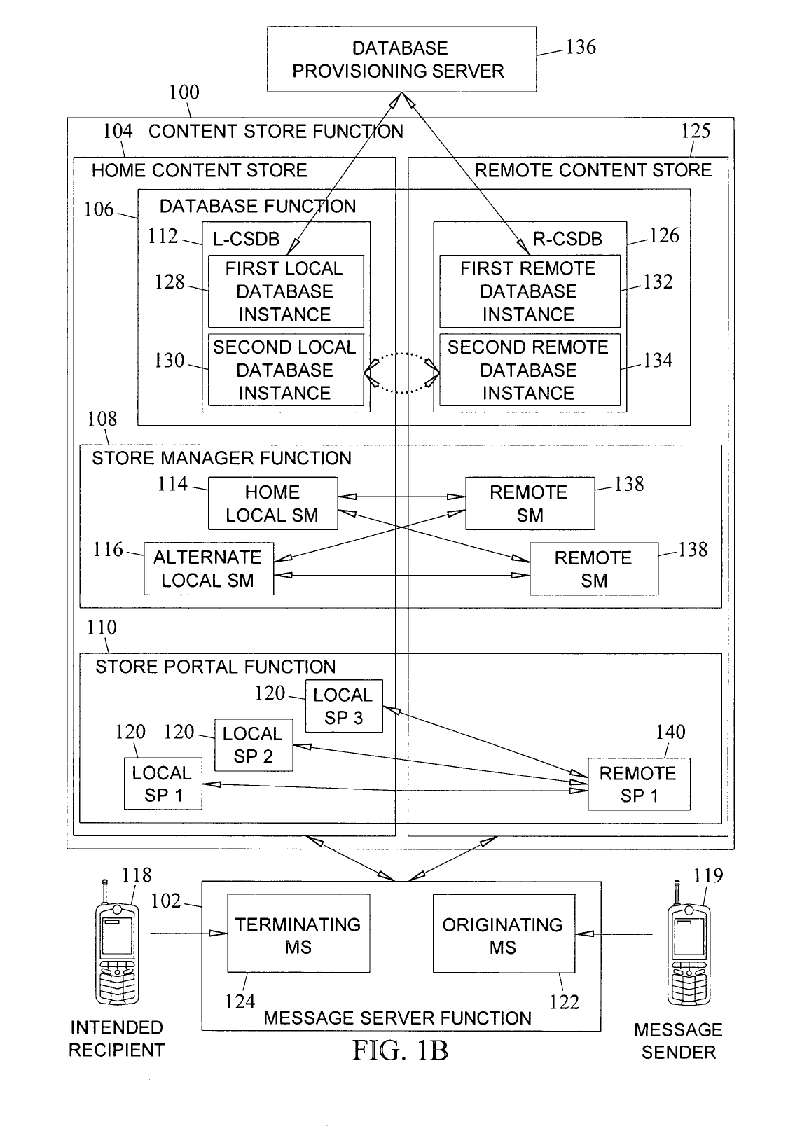

FIG. 1A is a block diagram of a redundant and independently scalable message service content store system according to the subject matter described herein. Referring to FIG. 1A, content storage and message routing functions may be separated into a content store function (CSF) 100 and a message server function (MSF) 102. It is appreciated that CSF 100 and MSF 102 may communicate via a suitable application programming interface (API) for allowing CSF 100 to be deployed as a “back-end” to an embodiment of MSF 102 supporting the API.

In FIG. 1A, CSF 100 may include a content store (CS) located in a first geographical location. For example, CSF 100 may include home content store (HCS) 104 for storing message service messages and managing a message queue for messages awaiting delivery. CSF 100 may also perform various administrative and measurement functions, such as maintaining statistical data regarding the number and size of stored messages and the amount of remaining storage capacity available. CSF 100 may store message service messages in a plurality of virtual “boxes”, such as an “inbox” for storing incoming messages, an “outbox” for storing outgoing messages, or an “n-box” for storing messages based on user-defined criteria. Message service subscribers may retrieve messages stored in any virtual box described above using, for example, an interface displayed on a message service-compatible client device and/or a graphical user interface displayed on a personal computer connected to the content store via any suitable telecommunications network, such as the Internet.

Messages or copies of messages may be maintained in any of the virtual boxes described above until the message service subscriber associated with the virtual box specifies that the messages should be deleted, archived, or forwarded to one or more messaging service addresses. A message service address may include, but is not limited to, an SMS/MMS address, an email address, a uniform resource identifier address, and an instant message address. For example, with regard to the forwarding of SMS/MMS messages to an email address, CSF 100 may include an interface suitable for the communication of messages in an electronic mail (email) format, such as simple mail transport protocol (SMTP). In this embodiment, CSF 100 may be configured to forward an SMS/MMS message directly to an email server. Alternatively, MSF 102 may include an interface suitable for the communication of messages in an email format, such as SMTP. For example, CSF 100 may direct an SMS/MMS message to MSF 102 and MSF 102 then may forward the SMS/MMS message to an email server.

In the embodiment shown in FIG. 1A, HCS 104 may be divided into a database function (DBF) 106 for storing message service content, a store manager function (SMF) 108 for managing queued messages, and a store portal function (SPF) 110 for performing internal routing functions within the CSF 100.

DBF 106 may include a content store database (CSDB) for storing message service message content. Message service message content may include, for example, audio, video, image or text data associated with message service messages. For example, CSDB 112 may store a text portion of an SMS message or may store a multimedia portion of an MMS message. It is appreciated that CSDB 112 may include any suitable database structure for storing message service message content. For example, CSDB 112 may include a structured query language (SQL) database, such as MySQL, which may be located on any suitable hardware platform or storage medium without departing from the scope of the subject matter described herein.

DBF 106 may communicate with SMF 108 and SPF 110 via any suitable communications medium, such as an internal communications bus within HCS 104. As will be described in greater detail below, data stored at CSDB 112 may be accessed via individual component functions of SMF 108 and SPF 110 in a redundant and independently scalable manner. Therefore, a plurality of entities included within HCS 104 may communicate with DBF 106 in order to, for example, retrieve stored message service messages awaiting delivery.

In addition to storing message content, CSDB 112 may store metadata associated with subscribers or message service messages stored by DBF 106, where metadata is distinct from message service message content. For example, CSDB 112 may store metadata including a subscriber identifier such as a text string, for identifying a subscriber associated with a message. A subscriber identifier may include an E.164 number or session initiation protocol (SIP) uniform resource indicator (URI). Metadata stored in CSDB 112 may also include a routing header that includes a domain name associated with a particular mobile station, where the domain name identified by the routing header can be assigned by a domain name system (DNS) server and/or an Internet protocol (IP) multimedia subsystem (IMS) network node. Additional types of metadata may track the length or creation time of stored messages, as well as the delivery status of messages. Such metadata may include message delivery indicators including “pending”, “delivery in progress”, and “delivered”. SMF 108 may include one or more store managers (SMs) 114-116 for queuing the delivery of messages and initiating retry attempts for undelivered messages. In the embodiment shown in FIG. 1A, SMF 108 includes plural redundantly connected SMs 114-116, where SMs 114-116 are located in the same geographic location. However, it is appreciated that SMs 114-116 may also be distributed across a plurality of geographically diverse locations and will be described with respect to FIG. 1B.

Returning to FIG. 1A, because SMs 114-116 are located in the same geographic location, each of SMs 114-116 may be identified as local SMs (L-SM). More specifically, from among L-SMs 114-116, preference may be given to a particular SM, that is associated with a particular set of subscribers. Therefore, for an individual subscriber, one of SMs 114-116 may be identified as a home local store manager (HL-SM) for that subscriber, and all other SMs 114-116 within SMF 108 may be identified as alternate local store managers (AL-SMs) for that subscriber. For example, in FIG. 1A, L-SM 114 is identified as HL-SM 114 for intended message recipient 118. Accordingly, a message received by HCS 104 and intended for recipient 118 may be routed to HL-SM 114 for processing.

In the event of a hardware, or other, failure of HL-SM 114, AL-SM 116 may detect the failure and perform the functions formerly performed by HL-SM 114. Therefore, it is appreciated that L-SMs 114-116 may redistribute message processing load in the event of a hardware failure and therefore provide increased availability over conventional message service content store systems. Additionally, in the absence of a hardware failure, an operator may add or remove one of SMs 114-116 in order to rebalance message processing loads across the plurality of store managers included in SMF 108. Accordingly, message processing capacity may be increased without requiring the purchase and maintenance of unneeded components.

Store portal function (SPF) 110 may include a plurality of SPs 120, where SPs 120 are redundantly interconnected in a manner similar to the manner described above with respect to SMs 114-116. A store portal, such as SP 120, may be the content store's interface to message servers and therefore may accept and process requests from message servers, such as MSs 122 and 124. SP 120 may also send autonomous requests to message servers 122 and 124 for events such as message retries. However, unlike SMs 114-116, subscribers are not homed to an individual SP 120 based on an associated subscriber, as they are with SMs 114-116. Rather, for a given message service message, an SP 120 may be selected for message processing based on a round-robin algorithm or other suitable method.

As discussed above, the subject matter described herein includes a message service message content store system that separates content store functions and message server functions into two independently scalable functions, CSF 100 and MSF 102. Therefore, MSF 102 will be described in greater detail below.

MSF 102 may include plural redundantly connected message servers (MSs) 122-124 for receiving and delivering message service messages to and from subscribers. MSs 122-124 may receive queued messages from CSF 100 and deliver them to client devices, such as message recipient 118, as well as perform delivery attempts for messages transmitted between subscribers. It is appreciated that MSs 122-124 may be independently scalable, redundantly interconnected, and functionally equivalent components and that individual MSs 122-124 may be added or removed by the network operator so that if an MS 122-124 fails, its workload may be redistributed among other MSs 122-124.

In an exemplary scenario illustrating the redundantly connected and independently scalable message service message content store system described herein, message sender 119 sends a message service message to intended recipient 118. In this scenario, it is assumed that no messages are stored awaiting delivery to message recipient 118 and that recipient 118 is unavailable for a first delivery attempt.

Message sender 119 may transmit the message service message to originating MS (O-MS) 122, where it is appreciated that the designation of a particular MS 122-124 as an O-MS for the message includes the MS in closest physical proximity to message sender 119. However, it is further appreciated that O-MS 122 is logically equivalent to MSs included in MSF 102, such as MS 124. O-MS 122 may route the message directly to a terminating message server (T-MS) 124, which includes the MS in closest physical proximity to intended message recipient 118. However, before T-MS 124 may attempt delivery of the message to subscriber 118, T-MS 124 may check for previously undelivered messages queued in CSF 100, and deliver those messages to the subscriber in the order they were received.

Therefore, T-MS 124 may query CSF 100 to determine whether any messages are queued for delivery to subscriber 118. This query may be transmitted to one of SPs 120 selected according to the round-robin algorithm described above. The selected SP 120 then may route the query to H-SM 114 associated with subscriber 118. H-SM 114 may then query CSDB 112 for any stored messages belonging to the subscriber. Because it is assumed in the present scenario that no stored messages exist, CSDB 112 may return an acknowledgment to H-SM 114 indicating that no messages are queued for the subscriber. Next, H-SM 114 communicate the query result to T-MS 124, which may then attempt delivery of the message to intended recipient 118.

In the present example, however, it is assumed that delivery attempt fails due to a network outage or congestion, for example. Rather than discarding the message, T-MS 124 sends the message to CSF 100 for storage until attempting to retry delivery. Similar to the communications path previously described, the message may be routed to the CSDB 112 via SPF 110 and SMF 108 and stored along with any associated metadata.

After storing the message after the failed first delivery attempt, H-SM 114 may wait a predetermined period of time before re-attempting delivery of the message. For example, H-SM 114 may maintain a retry schedule associated with the failure reason. After the predetermined time period has elapsed, H-SM 114 may retrieve the message from CSDB 112 and route it to T-MS 124 for delivery to subscriber 118. For purposes of this example, it is assumed that the second delivery attempt succeeds and therefore the message may be removed from CSDB 112. T-MS 124 may then generate a billing record indicating that the message was successfully delivered, and make that record available to other applications.

In addition to the independently scalable and redundantly connected embodiment described above, according to a second aspect of the message service content store system described herein, CSF 100 may be implemented in a geographically diverse manner. In addition to the advantages of the redundant and independently scalable embodiment illustrated in FIG. 1A, the geographically distributed, redundantly connected, and independently scalable MS content store system illustrated in FIG. 1B may provide increased fault tolerance based on an ability to maintain message processing in the event of substantial component failure. The system described herein may include routing messages to alternate content store sites and/or alternate components in the event of hardware failure.

In an embodiment of the subject matter described herein including a geographically diverse, redundantly connected, and independently scalable MS content store system, CSF 100 may include a local CS and a remote CS. For example, component functions of DBF 106, SMF 108, and SPF 110 may be distributed across multiple geographic locations and redundantly interconnected in a manner similar to that described above with respect to FIG. 1A.

In FIG. 1B, DBF 106 may be divided into local CSDB (L-CSDB) 112 and remote CSDB (R-CSDB) 126 replicated in a multi-master configuration, where L-CSDB 112 may be located in a first geographical location and R-CSDB 126 may be located in a second geographical location. Because L-CSDB 112 and R-CSDB 126 may receive write requests to write data to either of CSDBs 112 and 126 at any time, CSDBs 112 and 126 may each be further segregated in order to prevent data collisions between the L-CSDB 112 and R-CSDB 126 during synchronization.

L-CSDB 112 and R-CSDB 126 may each be divided into a first database instance (FDBI) and a second database instance (SDBI). For example, CSDB 106 may include FLDBI 128 and SLDBI 130, where the first and second database instances include replicated data. Additionally, FLDBI 128 may communicate with database provisioning server 136. SLDBI 130 may communicate with SRDBI 134 for replicating data.

In this embodiment, CSDBs 112 and 126 may be divided into multiple instances in order to comply with a rule of multi-master replicated databases prohibiting any “slave” function from simultaneously serving more than one “master” function. It is appreciated that the embodiment illustrated in FIG. 1B is a suitable embodiment of the subject matter described herein for providing plural databases replicated in a multi-master configuration.

In order to prevent collisions of data being replicated between L-CSDB 112 and R-CSDB 126 and/or data corruption of either database, SPs 118-120 may also generate unique indexes associated with records stored in DBF 106. The indexes may indicate which, for example, whether a record was created and require that any subsequent modifications or deletions of the record be performed by the same CS. By utilizing the indexes described above, records may be prevented from being simultaneously created or updated by multiple sites and prevents potential corruption of the databases located at each site during synchronization.

In order to illustrate the geographically diverse and redundant MMS system described herein, exemplary steps for routing messages in the event of various hardware component failures are described herein. In each of the following exemplary scenarios, it is assumed that message sender 119 transmits a message to intended recipient 118 via O-MS 122 and T-MS 124. It is further assumed that each scenario involves the failure of one or more component functions of CSF 100, and consequently, the alternative routes the message may traverse within CSF 100 prior to successful delivery.

In a first scenario, T-MS 124 initiates a query to determine whether subscriber 118 has any stored messages awaiting delivery. The query may be routed to HL-SM 114 which may be responsible for directly querying L-CSDB 112 containing messages associated with the subscriber. However, in this example it is assumed that L-CSDB 112 is unavailable. Therefore, HL-SM 114 may instead query R-CSDB 126 containing a remote copy of L-CSDB 112. The information returned by R-CSDB 126 may be processed by HL-SM 114 and any stored messages may be delivered to subscriber 118.

In a second scenario, it is assumed that all of local SMs 114-116 become unavailable. Therefore, messages may be routed around the failed SMs to remote content store site 125, where one or more remote SMs 138 are utilized. Specifically, each of remote SMs 138 may be configured to detect the failure of one or more local SMs 114-116 and, in response to detecting a failure, to perform the functions formerly performed by local SMs 114-116.

In a third scenario, all of local SPs 120 become unavailable. Therefore, messages may be routed around the failed SPs to remote SP 140. However, it is appreciated that, in the example illustrated in FIG. 1B, SPs 120 and 140 are not symmetrically distributed across HCS 104 and RCS 125.

The subject matter described herein may maintain availability of messaging services in the event that one or all local SPs become unavailable as well. If a local SP fails, one of MSs 122-124 may send messages using one of alternative SPs 120. In the event that all local SPs 120 fail, messages may be routed through one or more remote SPs 140.

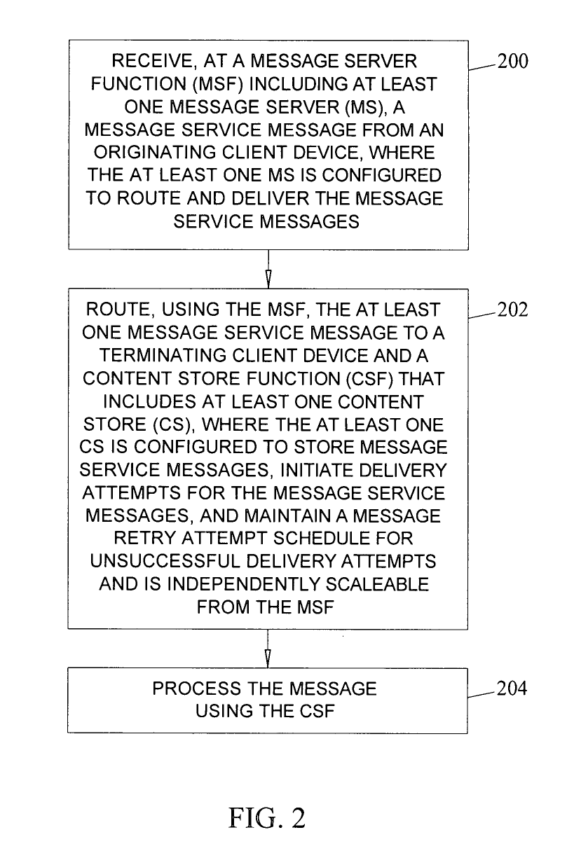

FIG. 2 is a flow chart illustrating exemplary steps for providing messaging services in a geographically diverse, redundant, and independently scalable message service content store system according to the subject matter described herein. Referring to FIG. 2, in block 200, a message service message is received at a message server function (MSF) including at least one message server (MS). The at least one MS may be configured to route and deliver message service messages, for example to an intended message recipient's terminating client device.

In block 202, using the MSF, the at least one message service message is routed to a content store function (CSF) that includes at least one content store (CS), where the at least one CS is configured to store message service messages, initiate delivery attempts for the message service messages, and maintain a message retry attempt schedule for unsuccessful delivery attempts and is independently scalable from the MSF.

In block 204, the message is processed using the CSF. Processing the message may include, for example, retrieving queued messages awaiting delivery for the subscriber. As described above, it is appreciated that advantages of the redundant, geographically distributed, and independently scalable multimedia messaging service content store system described herein include reliability, scalability, and efficiency. By separating a traditional message center into a separate CSF 100 and MSF 102 components, the subject matter herein allows operators to optimize their messaging systems for specific network demands by allowing them to add or remove functions without affecting others. MMS system efficiency is thereby increased, especially for networks in which message storage and routing demand increase and decrease independently.

Moreover, by geographically distributing the components of CSF 100 and MSF 102, the subject matter described herein also allows operators to optimize their multimedia message services based on different messaging patterns for subscribers in different geographic regions.

Further, by redundantly connecting geographically distributed functions, the subject matter described herein provides greater reliability than current methods and systems in the event of significant local message service component unavailability.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A scalable multimedia message service message storage and delivery system, the system comprising:
(a) a content store function (CSF) including at least one content store (CS) configured to store message service messages, initiate delivery attempts for the message service messages, and maintain a message retry attempt schedule for unsuccessful delivery attempts; and
(b) a message server function (MSF) including at least one message server (MS) configured to route and deliver the message service messages, wherein the MSF is scalable independently from the CSF.

2. The system of claim 1 wherein the CSF and the MSF are located on separate hardware platforms.

3. The system of claim 1 wherein the CSF and the MSF are located in separate geographical locations.

4. The system of claim 1 wherein the CSF comprises:
(a) a database function (DBF) including a content store database (CSDB) for storing subscriber information and the message service messages;
(b) a store manager function (SMF) including at least one store manager (SM) for managing message service messages, queuing message service messages, and initiating retries for failed deliveries, wherein the SMF is scalable independently from the DBF; and
(c) a store portal function (SPF) including at least one store portal (SP) for interfacing with the MSF, SMF and DBF, wherein the SPF is scalable independently from the SMF and DBF.

5. The system of claim 4 wherein the at least one SP includes first and second SPs, wherein the first SP is adapted to detect failure of the second SP and, in response to detecting the failure of the second SP, the first SP is adapted to perform functions formerly performed by the second SP.

6. The system of claim 4 wherein the at least one SM includes first and second SMs, wherein the first SM is adapted to detect failure of the second SM and, in response to detecting failure of the second SM, the first SM is adapted to perform the functions formerly performed by the second SM.

7. The system of claim 4 wherein the DBF includes a plurality of CSDBs located in a plurality of geographic locations, wherein the CSDBs are replicated in a multi-master configuration.

8. The system of claim 7 wherein each CSDB comprises a first database instance (FDBI) and a second database instance (SDBI), wherein the FDBI receives data from a database provisioning server (DPS) and the SDBI replicates the data received by the FDB1.

9. The system of claim 8 wherein the at least one SM comprises a home store manager (HSM) for storing message service messages for a first set of subscribers being homed to a network of the HSM.

10. The system of claim 9 wherein the at least one store manager comprises an alternate store manager (ASM) for storing message service messages for a second set of subscribers not homed to the HSM.

11. The system of claim 4 wherein the at least one SM comprises a plurality of SMs and wherein subscribers are equally divided among the SMs.

12. The system of claim 11 wherein the ASM is adapted to detect the failure of the HSM and, in response, become the HSM for the first set of subscribers.

13. The system of claim 4 wherein the at least one SP comprises a first SP having a local store portal (L-SP) in a first location and a second SP having a remote store portal (R-SP) locate din a second geographical location, wherein the one or more R-SPs and the one or more L-SPs are subsets of the one or more SPs.

14. The system of claim 1 wherein the CSF includes a virtual message box.

15. The system of claim 4 wherein the CSF including the virtual message box is configured to forward a message service message from the virtual message box to one or more message service addresses.

16. The method of claim 1 wherein the CSF is adapted to forward message service messages to an email server.

17. A method for providing scalable message service message storage and delivery, the method comprising:
(a) receiving, at a message server function (MSF) including at least one message server (MS), a message service message;
(b) routing, using the MSF, the at least one message service message to a content store function (CSF) that includes at least one content store (CS), where the at least one CS is configured to store message service messages, initiate delivery attempts for the message service messages, and maintain a message retry attempt schedule for unsuccessful delivery attempts and is independently scalable from the MSF; and
(c) processing the message using the CSF.

18. The method of claim 17 wherein routing the message service message to a CSF using the MSF includes routing the message between separate geographic locations.

19. The method of claim 17 wherein routing the message service message to a CSF includes routing the message to a CSF located in a geographic location that is different from the geographic location of the MSF.

20. The method of claim 17 wherein processing the message service message using the CSF includes:
(a) routing the message service message to a store portal (SP), the SP being part of a store portal function (SPF);
(b) processing the message service message at a home store manager (H-SM), the H-SM being part of a store manager function (SMF); and
(c) storing the message service message at a content store database (CSDB), the CSDB being part of a database function (DBF).

21. The method of claim 20 wherein routing the message service message to an SP includes:
(a) detecting the unavailability of a first SP by a message server (MS); and
(b) in response to detecting the unavailability of the first SP, routing the message to a second SP.

22. The method of claim 20 wherein processing the message service message at an H-SM includes:
(a) detecting the unavailability of a first SM; and
(b) in response to detecting the unavailability of the first :SM, processing the message using a second SM.

23. The method of claim 20 wherein processing the message service message includes storing the message service message in a virtual message box.

24. The method of claim 23 wherein processing the message service message includes forwarding the message service message from the virtual message box to one or more message service addresses.

25. A computer program product for providing scalable message services (MS) message storage, the computer program product comprising computer executable instructions embodied in a computer readable medium for performing steps comprising:
(a) receiving, at a message server function (MSF) including at least one message server (MS), a message service message;
(b) routing, using the MSF, the at least one message service message to a content store function (CSF) that includes at least one content store (CS), where the at least one CS is configured to store message service messages, initiate delivery attempts for the message service messages, and maintain a message retry attempt schedule for unsuccessful delivery attempts and is independently scalable from the MSF; and
(c) processing the message using the CSF.
